(19) United States
(12) Patent Application Publication
(10) Pub. No.: US 2025/0364164 A1
(43) Pub. Date: Nov. 27, 2025

(54) IRON NITRIDE PERMANENT MAGNET AND TECHNIQUE FOR FORMING IRON NITRIDE PERMANENT MAGNET

(71) Applicant: Regents of the University Of Minnesota, Minneapolis, MN (US)

(72) Inventors: Jian-Ping Wang, Shoreview, MN (US); Shihai He, Fremont, CA (US); Yanfeng Jiang, Minneapolis, MN (US)

(21) Appl. No.: 19/293,562

(22) Filed: Aug. 7, 2025

Related U.S. Application Data
(63) Continuation of application No. 18/348,830, filed on Jul. 7, 2023, now Pat. No. 12,412,686.
Application No. 18/348,830 is a division of application No. 16/003,428, filed on Jun. 8, 2018, now Pat. No. 11,742,117.
Application No. 16/003,428 is a division of application No. 14/238,835, filed on Jun. 9, 2014, now Pat. No. 10,068,689.
(60) Provisional application No. 61/524,423, filed on Aug. 17, 2011.

(51) Int. Cl. H01F 1/01; B22D 11/06; B32B 15/01; C21D 1/76; C22C 38/00; C23C 8/26; C23C 8/80; H01F 1/047; H01F 7/02; H01F 41/02

(52) U.S. Cl. CPC H01F 1/01; B22D 11/0622; B22D 11/0651; B32B 15/011; C21D 1/76; C22C 38/001; C23C 8/26; C23C 8/80; H01F 1/047; H01F 7/021; H01F 41/0253; H01F 41/0273

(57) ABSTRACT

A permanent magnet may include a Fe₁₆N₂ phase constitution. In some examples, the permanent magnet may be formed by a technique that includes straining an iron wire or sheet comprising at least one iron crystal in a direction substantially parallel to a <001> crystal axis of the iron crystal; nitridizing the iron wire or sheet to form a nitridized iron wire or sheet; annealing the nitridized iron wire or sheet to form a Fe₁₆N₂ phase constitution in at least a portion of the nitridized iron wire or sheet; and pressing the nitridized iron wires and sheets to form bulk permanent magnet.

### CROSS REFERENCE TO RELATED APPLICATIONS

This application is a continuation of U.S. patent application Ser. No. 18/348,830, filed Jul. 7, 2023, which is a divisional of U.S. patent application Ser. No. 16/003,428, filed Jun. 8, 2018, is a divisional of U.S. patent application Ser. No. 14/238,835, filed Jun. 9, 2014, which is a national stage entry under 35 U.S.C. § 371 of International Application No. PCT/US2012/051382, filed Aug. 17, 2012, which claims the benefit of application No. 61/524,423, filed Aug. 17, 2011. The entire contents of International Application No. PCT/US2012/051382 and U.S. Provisional Patent Application 61/524,423 are incorporated herein by reference.

### GOVERNMENT RIGHTS

This invention was made with government support under DE-AR0000199 awarded by the U.S. Department of Energy. The government has certain rights in the invention.

### TECHNICAL FIELD

The disclosure relates to permanent magnets and techniques for forming permanent magnets.

### BACKGROUND

Permanent magnets play a role in many electro-mechanical systems, including, for example, alternative energy systems. For example, permanent magnets are used in electric motors or generators, which may be used in vehicles, wind turbines, and other alternative energy mechanisms. Many permanent magnets in current use include rare earth elements, such as neodymium. These rare earth elements are in relatively short supply, and may face increased prices and/or supply shortages in the future. Additionally, some permanent magnets that include rare earth elements are expensive to produce. For example, fabrication of NdFeB magnets generally includes crushing material, compressing the material, and sintering at temperatures over 1000° C.

### SUMMARY

In general, this disclosure is directed to bulk permanent magnets that include Fe₁₆N₂ and techniques for forming bulk permanent magnets that include Fe₁₆N₂. Bulk Fe₁₆N₂ permanent magnets may provide an alternative to permanent magnets that include a rare earth element. Iron and nitrogen are abundant elements, and thus are relatively inexpensive and easy to procure. Additionally, experimental evidence gathered from thin film Fe₁₆N₂ permanent magnets suggests that bulk Fe₁₆N₂ permanent magnets may have desirable magnetic properties, including an energy product of as high as about 134 MegaGauss*Oerstads (MGOe), which is about two times the energy product of NdFeB (about 60 MGOe). The high energy product of Fe₁₆N₂ magnets may provide high efficiency for applications in electric motors, electric generators, and magnetic resonance imaging (MRI) magnets, among other applications.

In some aspects, the disclosure describes techniques for forming bulk Fe₁₆N₂ permanent magnets. The techniques may generally include straining an iron wire or sheet, that includes at least one body centered cubic (bcc) iron crystal, along a direction substantially parallel to a <001> crystal axis of the at least one bcc iron crystal. In some examples, the <001> crystal axis of the at least one iron wire or sheet may lie substantially parallel to a major axis of the iron wire or sheet. The techniques then include exposing the iron wire or sheet to a nitrogen environment to introduce nitrogen into the iron wire or sheet. The techniques further include annealing the nitridized iron wire or sheet to order the arrangement of iron and nitrogen atoms and form the Fe₁₆N₂ phase constitution in at least a portion of the iron wire or sheet. In some examples, multiple Fe₁₆N₂ wires or sheets can be assembled with substantially parallel <001> axes and the multiple Fe₁₆N₂ wires or sheets can be pressed together to form a permanent magnet including a Fe₁₆N₂ phase constitution.

In some aspects, the disclosure describes techniques for forming single crystal iron nitride wires and sheets. In some examples, a Crucible technique, such as that described herein, may be used to form single crystal iron nitride wires and sheets. In addition to such Crucible techniques, such single crystal iron wires and sheets may be formed by either the micro melt zone floating or pulling from a micro shaper. Furthermore, techniques for forming crystalline textured (e.g., with desired crystalline orientation along the certain direction of wires and sheets) iron nitride wires and sheet are also described.

In one example, the disclosure is directed to a method that includes straining an iron wire or sheet comprising at least one iron crystal in a direction substantially parallel to a <001> crystal axis of the iron crystal; nitridizing the iron wire or sheet to form a nitridized iron wire or sheet; and annealing the nitridized iron wire or sheet to form a Fe₁₆N₂ phase constitution in at least a portion of the nitridized iron wire or sheet. In another example, the disclosure is directed to a system that includes means for straining an iron wire or sheet comprising at least one body centered cubic (bcc) iron crystal in a direction substantially parallel to a <001> axis of the bcc iron crystal; means for heating the strained iron wire or sheet; means for exposing the strained iron wire or sheet to an atomic nitrogen precursor to form a nitridized iron wire or sheet; and means for annealing the nitridized iron wire or sheet to form a Fe₁₆N₂ phase constitution in at least a portion of the nitridized iron wire or sheet.

In another aspect, the disclosure is directed to a method that includes urea as an effective atomic nitrogen source to diffuse nitrogen atoms into iron to form a nitridized iron wire or sheet or bulk.

In another aspect, the disclosure is directed to a permanent magnet that includes a wire comprising a Fe₁₆N₂ phase constitution.

In another aspect, the disclosure is directed to a permanent magnet that includes a sheet comprising a Fe₁₆N₂ phase constitution.

In another aspect, the disclosure is directed to a permanent magnet that includes a Fe₁₆N₂ phase constitution. According to this aspect of the disclosure, the permanent magnet has a size in at least one dimension of at least 0.1 mm

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1 is a flow diagram that illustrates an example technique for forming a bulk Fe₁₆N₂ permanent magnet.

FIG. 2 is a conceptual diagram illustrating an example apparatus with which an iron wire or sheet can be strained and exposed to nitrogen.

FIG. 3 illustrates further detail of one example of the Crucible heating stage shown in FIG. 2.

FIG. 4 is a conceptual diagram that shows eight (8) iron unit cells in a strained state with nitrogen atoms implanted in interstitial spaces between iron atoms.

FIGS. 5A and 5B are conceptual diagrams that illustrate an example of the compression process for combining multiple iron wires or sheets into a permanent magnet.

FIG. 6 is a conceptual diagram illustrating another example apparatus with which an iron wire or sheet can be strained.

FIG. 7 is a schematic diagram illustrating an example apparatus that may be used for nitriding an iron wire or sheet via a urea diffusion process.

FIG. 8 is an iron nitride phase diagram.

FIGS. 9-12 are graphs of various results for example experiments carried out to illustrate aspects of the disclosure.

FIG. 13 is a conceptual diagram illustrating an example apparatus for fast belt casting to texture an example iron nitride wire or sheet.

### DETAILED DESCRIPTION OF ILLUSTRATIVE EMBODIMENTS

In general, the disclosure is directed to permanent magnets that include a Fe₁₆N₂ phase constitution and techniques for forming permanent magnets that include a Fe₁₆N₂ phase constitution. In particular, the techniques described herein are used to form bulk phase Fe₁₆N₂ permanent magnets.

Fe₁₆N₂ permanent magnets may provide a relatively high energy product, for example, as high as about 134 MGOe when the Fe₁₆N₂ permanent magnet is anisotropic. In examples in which the Fe₁₆N₂ magnet is isotropic, the energy product may be as high as about 33.5 MGOe. The energy product of a permanent magnetic is proportional to the product of remanent coercivity and remanent magnetization. For comparison, the energy product of Nd₂Fe₁₄B permanent magnet may be as high as about 60 MGOe. A higher energy product can lead to increased efficiency of the permanent magnet when used in motors, generators, or the like.

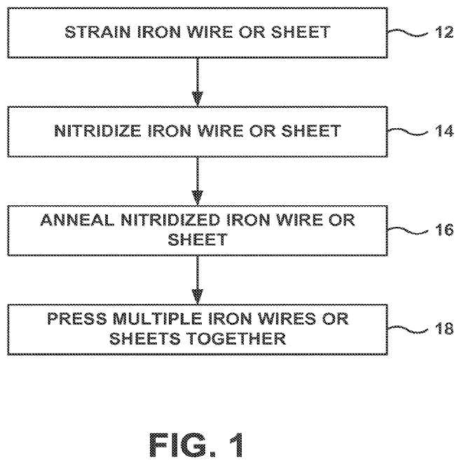

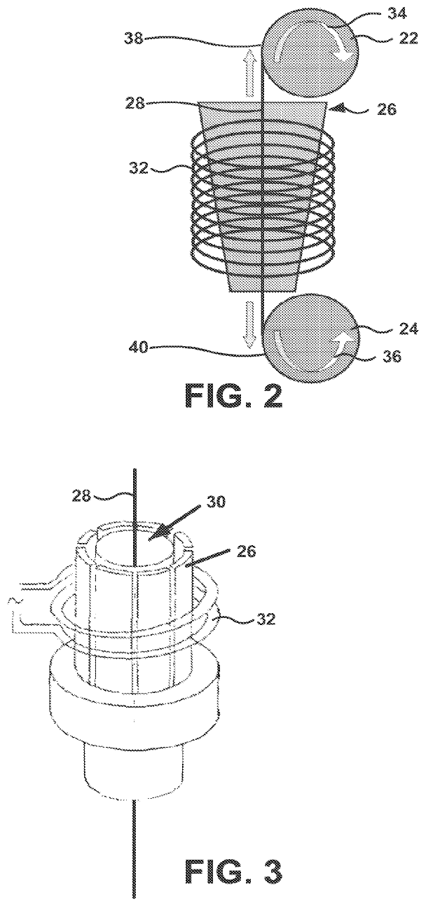

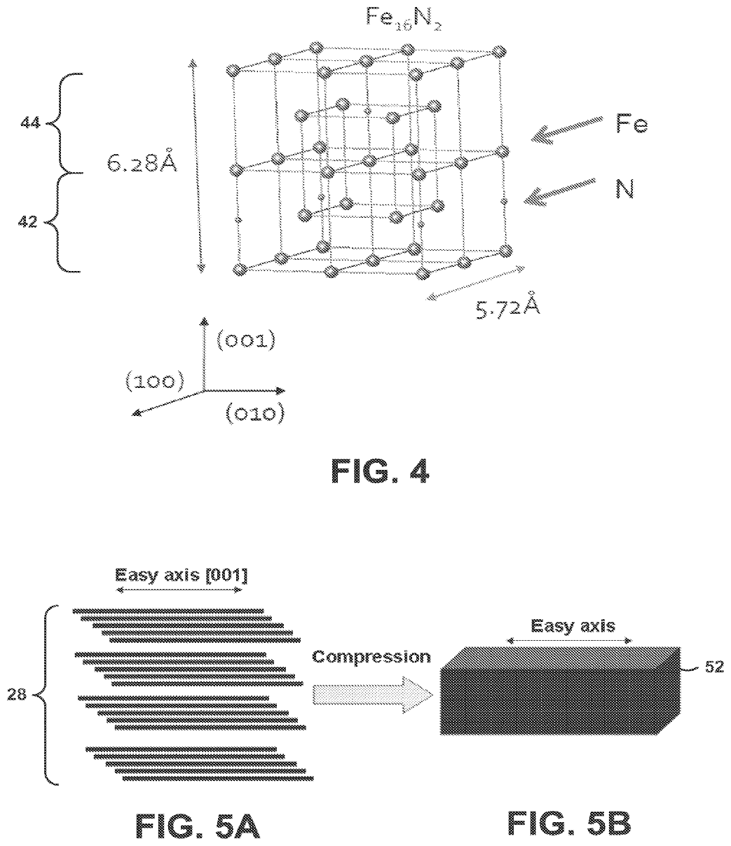

FIG. 1 is a flow diagram that illustrates an example technique for forming a bulk Fe₁₆N₂ permanent magnet. The technique of FIG. 1 will be described with concurrent reference to FIGS. 2-5. FIG. 2 illustrates a conceptual diagram of an apparatus with which the iron wire or sheet can be strained and exposed to nitrogen. FIG. 3 illustrates further detail of one example of the Crucible heating stage shown in FIG. 2.

The example apparatus of FIG. 2 includes a first roller 22, a second roller 24, and a Crucible heating stage 26. First roller 22 and second roller 24 are configured to receive a first end 38 and a second end 40, respectively, of an iron wire or sheet 28. Iron wire or sheet 28 defines a major axis between first end 38 and second end 40. As best seen in FIG. 3, iron wire or sheet 28 passes through an aperture 30 defined by Crucible heating stage 26. Crucible heating stage 26 includes an inductor 32 that surrounds at least a portion of the aperture 30 defined by Crucible heating stage 26.

The example technique of FIG. 1 includes straining iron wire or sheet 28 along a direction substantially parallel (e.g., parallel or nearly parallel) to a <001> axis of at least one iron crystal in the iron wire or sheet 28 (12). In some examples, iron wire or sheet 28 is formed of iron having a body centered cubic (bcc) crystal structure.

In some examples, iron wire or sheet 28 is formed of a single bcc crystal structure. In other examples, iron wire or sheet 28 may be formed of a plurality of bcc iron crystals. In some of these examples, the plurality of iron crystals are oriented such that at least some, e.g., a majority or substantially all, of the <001> axes of individual unit cells and/or crystals are substantially parallel to the direction in which strain is applied to iron wire or sheet 28. For example, when the iron is formed as iron wire or sheet 28, at least some of the <001> axes may be substantially parallel to the major axis of the iron wire or sheet 28, as shown in FIGS. 2 and 3. As noted above, in some examples, single crystal iron nitride wires and sheets may be formed using Crucible techniques. In addition to such Crucible techniques, single crystal iron wires and sheets may be formed by either the micro melt zone floating or pulling from a micro shaper to form iron wire or sheet 28.

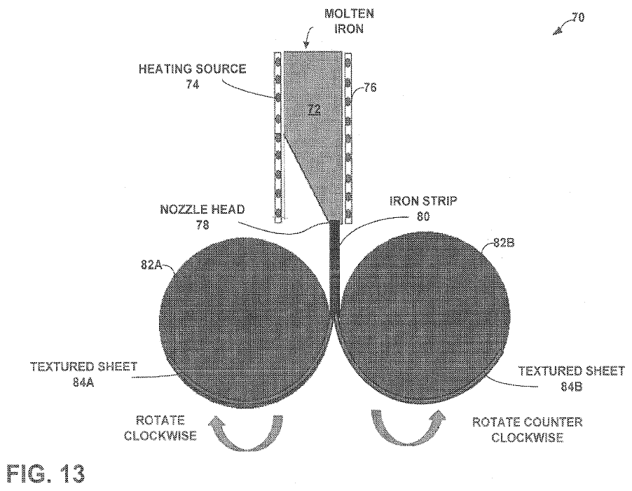

In some examples, iron wire or sheet 28 may have a crystalline textured structure. Techniques may be used to form crystalline textured (e.g., with desired crystalline orientation along the certain direction of wires and sheets) iron wires or sheet 28. FIG. 13 is a conceptual diagram illustrating one example apparatus 70 for fast belt casting to texture an example iron wire or sheet, such as iron wire or sheet 28. As shown fast belt casting apparatus 70 includes ingot chamber 76 which contains molten iron ingot 72, which may be heated by heating source 74, e.g., in the form of a heating coil. Ingot 72 flow out of chamber 76 through nozzle head 78 to form iron strip 80. Iron strip 80 is fed into the gap zone between surface of pinch rollers 82A and 82B, which are rotated in opposite directions. In some examples, the rotation of roller 82A and 82B may vary from approximately 10 to 1000 rotations per minute. Iron strip cools on pinch rollers 82A and 82B and, after being pressed between pinch rollers 82A and 82B, forms textured iron strips 84A and 84B. In some examples, texted iron strips 84A and 84B may form textured iron ribbon with thickness between, e.g., about one micrometer and about a millimeter (either individually or after compression of multiple iron strips.

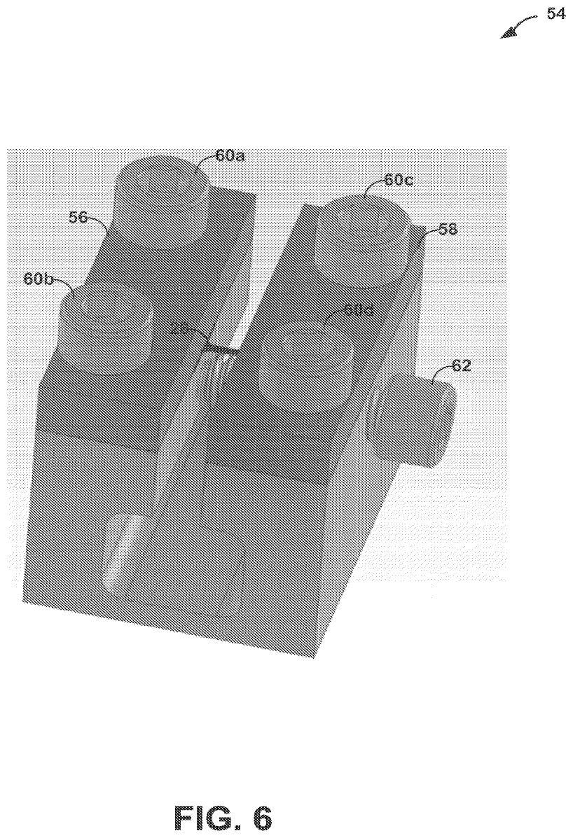

In an unstrained iron bcc crystal lattice, the <100>, <010>, and <001> axes of the crystal unit cell may have substantially equal lengths. However, when a force, e.g., a tensile force, is applied to the crystal unit cell in a direction substantially parallel to one of the crystal axes, e.g., the <001> crystal axis, the unit cell may distort and the iron crystal structure may be referred to as body centered tetragonal (bet). For example, FIG. 4 is a conceptual diagram that shows eight (8) iron unit cells in a strained state with nitrogen atoms implanted in interstitial spaces between iron atoms. The example in FIG. 4 includes four iron unit cells in a first layer 42 and four iron unit cells in a second layer 44. Second layer 44 overlays first layer 42 and the unit cells in second layer 44 are substantially aligned with the unit cells in first layer 42 (e.g., the <001> crystal axes of the unit cells are substantially aligned between the layers). As shown in FIG. 4, the iron unit cells are distorted such that the length of the unit cell along the <001> axis is approximately 3.14 angstroms (Å) while the length of the unit cell along the <010> and <100> axes is approximately 2.86 Å. The iron unit cell may be referred to as a bet unit cell when in the strained state. When the iron unit cell is in the strained state, the <001> axis may be referred to as the c-axis of the unit cell.

The stain may be exerted on iron wire or sheet 28 using a variety of strain inducing apparatuses. For example, as shown in FIG. 2, first end 38 and second end 40 of iron wire or sheet 28 may received by (e.g., wound around) first roller 22 and second roller 24, respectively, and rollers 22, 24 may be rotated in opposite directions (indicated by arrows 34 and 35 in FIG. 2) to exert a tensile force on the iron wire or sheet 28.

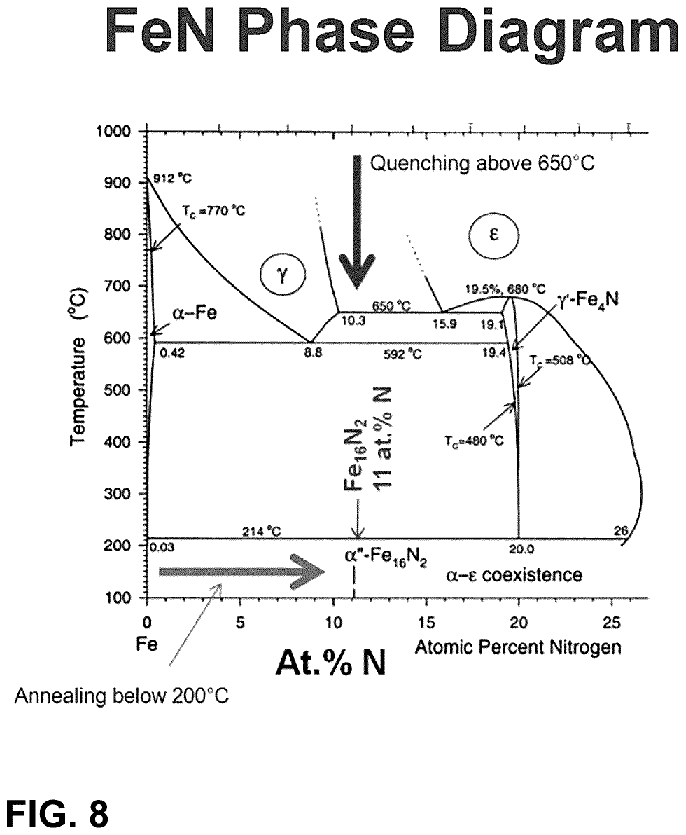

In other examples, opposite ends of iron wire or sheet 28 may be gripped in mechanical grips, e.g., clamps, and the mechanical grips may be moved away from each other to exert a tensile force on the iron wire or sheet 28. FIG. 6 is a conceptual diagram illustrating another example apparatus with which iron wire or sheet 28 can be strained as described herein. As shown, apparatus 54 includes clamps 56 and 58 which may secure opposing ends of iron wire or sheet 28 by tightening screws 60a-d. Once iron wire or sheet is secured in apparatus 19, bolt 62 may be turned to rotate the threaded body of bolt 62 to increase the distance between clamps 56 and 58 and exert a tensile force on iron wire or sheet 28. The value of the elongation or stress generated by the rotation of bolt 62 may be measured by any suitable gauge, such as, e.g., a strain gauge. In some examples, apparatus 54 may be placed in a furnace (e.g., a tube furnace) or other heated environment so that iron wire or sheet 28 may be heated during and/or after iron wire or sheet 28 is stretched by apparatus 54.

A strain inducing apparatus may strain iron wire or sheet 28 to a certain elongation. For example, the strain on iron wire or sheet 28 may be between about 0.3% and about 7%. In other examples, the strain on iron wire or sheet 28 may be less than about 0.3% or greater than about 7%. In some examples, exerting a certain strain on iron wire or sheet 28 may result in a substantially similar strain on individual unit cells of the iron, such that the unit cell is elongated along the <001> axis between about 0.3% and about 7%. Iron wire or sheet 28 may have any suitable diameter and/or thickness. In some examples, a suitable diameter and/or thickness may be on the order of micrometers (μm) or millimeters (mm). For example, an iron wire may have a diameter greater than about 10 μm (0.01 mm). In some examples, the iron wire has a diameter between about 0.01 mm and about 1 mm, such as about 0.1 mm.

Similarly, an iron sheet may have any suitable thickness and/or width. In some examples, the iron sheet may have a thickness greater than about 0.01 mm, such as between about 0.01 mm and about 1 mm, or about 0.1 mm. In some implementations, a width of the iron sheet may be greater than a thickness of the iron sheet.

A diameter of the iron wire or cross-sectional area of the iron sheet (in a plane substantially orthogonal to the direction in which the iron sheet is stretched/strained) may affect an amount of force that must be applied to iron wire or sheet 28 to result in a given strain. For example, the application of approximately 144 N of force to an iron wire with a diameter of about 0.1 mm may result in about a 7% strain. As another example, the application of approximately 576 N of force to an iron wire with a diameter of about 0.2 mm may result in about a 7% strain. As another example, the application of approximately 1296 N of force to an iron wire with a diameter of about 0.3 mm may result in about a 7% strain. As another example, the application of approximately 2304 N of force to an iron wire with a diameter of about 0.4 mm may result in about a 7% strain. As another example, the application of approximately 3600 N of force to an iron wire with a diameter of about 0.5 mm may result in about a 7% strain.

In some examples, iron wire or sheet 28 may include dopant elements which serve to stabilize the Fe₁₆N₂ phase constitution once the Fe₁₆N₂ phase constitution has been formed. For example, the phase stabilization dopant elements may include cobalt (Co), titanium (Ti), copper (Cu), zinc (Zn), or the like.

As the strain inducing apparatus exerts the strain on iron wire or sheet 28 and/or once the strain inducing apparatus is exerting a substantially constant strain on the iron wire or sheet 28, iron wire or sheet 28 may be nitridized (14). In some examples, during the nitridization process, iron wire or sheet 28 may be heated using a heating apparatus. One example of a heating apparatus that can be used to heat iron wire or sheet 28 is Crucible heating stage 26, shown in FIGS. 2 and 3.

Crucible heating stage 26 defines aperture 30 through which iron wire or sheet 28 passes (e.g., in which a portion of iron wire or sheet 28 is disposed). In some examples, no portion of Crucible heating stage 26 contacts iron wire or sheet 28 during the heating of iron wire or sheet 28. In some implementations, this is advantageous as it lower a risk of unwanted elements or chemical species contacting and diffusing into iron wire or sheet 28. Unwanted elements or chemical species may affect properties of iron wire or sheet 28; thus, it may be desirable to reduce or limit contact between iron wire or sheet 28 and other materials.

Crucible heating stage 26 also includes an inductor 32 that surrounds at least a portion of aperture 30 defined by Crucible heating stage 26. Inductor 32 includes an electrically conductive material, such as aluminum, silver, or copper, through which an electric current may be passed. The electric current may by an alternating current (AC), which may induce eddy currents in iron wire or sheet 28 and heat the iron wire or sheet 28. In other examples, instead of using Crucible heating stage 26 to heat iron wire or sheet 28, other non-contact heating sources may be used. For example, a radiation heat source, such as an infrared heat lamp, may be used to heat iron wire or sheet 28. As another example, a plasma arc lamp may be used to heat iron wire or sheet 28.

Regardless of the heating apparatus used to heat iron wire or sheet 28 during the nitridizing process, the heating apparatus may heat iron wire or sheet 28 to temperature for a time sufficient to allow diffusion of nitrogen to a predetermined concentration substantially throughout the thickness or diameter of iron wire or sheet 28. In this manner, the heating time and temperature are related, and may also be affected by the composition and/or geometry of iron wire or sheet 28. For example, iron wire or sheet 28 may be heated to a temperature between about 125° C. and about 600° C. for between about 2 hours and about 9 hours. In some examples, iron wire or sheet 28 may be heated to a temperature between about 500° C. and about 600° C. for between about 2 hours and about 4 hours.

In some examples, iron wire or sheet 28 includes an iron wire with a diameter of about 0.1 mm. In some of these examples, iron wire or sheet 28 may be heated to a temperature of about 125° C. for about 8.85 hours or a temperature of about 600° C. for about 2.4 hours. In general, at a given temperature, the nitridizing process time may be inversely proportional to a characteristic dimension squared of iron wire or sheet 28, such as a diameter of an iron wire or a thickness of an iron sheet.

In addition to heating iron wire or sheet 28, nitridizing iron wire or sheet 28 (14) includes exposing iron wire or sheet 28 to an atomic nitrogen substance, which diffuses into iron wire or sheet 28. In some examples, the atomic nitrogen substance may be supplied as diatomic nitrogen (N₂), which is then separated (cracked) into individual nitrogen atoms. In other examples, the atomic nitrogen may be provided from another atomic nitrogen precursor, such as ammonia (NH₃). In other examples, the atomic nitrogen may be provided from urea (CO(NH₂)₂).

The nitrogen may be supplied in a gas phase alone (e.g., substantially pure ammonia or diatomic nitrogen gas) or as a mixture with a carrier gas. In some examples, the carrier gas is argon (Ar). The gas or gas mixture may be provided at any suitable pressure, such as between about 0.001 Torr (about 0.133 pascals (Pa)) and about 10 Torr (about 1333 Pa), such as between about 0.01 Torr (about 1.33 Pa) and about 0.1 Torr (about 13.33 Torr). In some examples, when the nitrogen is delivered as part of a mixture with a carrier gas, the partial pressure of nitrogen or the nitrogen precursor (e.g., NH₃) may be between about 0.02 and about 0.1.

The nitrogen precursor (e.g., N₂ or NH₃) may be cracked to form atomic nitrogen substances using a variety of techniques. For example, the nitrogen precursor may be heated using radiation to crack the nitrogen precursor to form atomic nitrogen substances and/or promote reaction between the nitrogen precursor and iron wire or sheet 28. As another example, a plasma arc lamp may be used to split the nitrogen precursor to form atomic nitrogen substances and/or promote reaction between the nitrogen precursor and iron wire or sheet 28.

In some examples, iron wire or sheet 28 may be nitridized (14) via a urea diffusion process, in which urea is utilized as a nitrogen source (e.g., rather than diatomic nitrogen or ammonia). Urea (also referred to as carbamide) is an organic compound with the chemical formula CO(NH₂)₂ that may be used in some cases as a nitrogen release fertilizer. To nitridize iron wire or sheet 28 (14), urea may heated, e.g., within a furnace with iron wire or sheet 28, to generate decomposed nitrogen atoms which may diffuse into iron wire or sheet 28. As will be described further below, the constitution of the resulting nitridized iron material may controlled to some extent by the temperature of the diffusion process as well as the ratio (e.g., the weight ratio) of iron to urea used for the process. In other examples, iron wire or sheet 28 may be nitridized by an implantation process similar to that used in semiconductor processes for introducing doping agents.

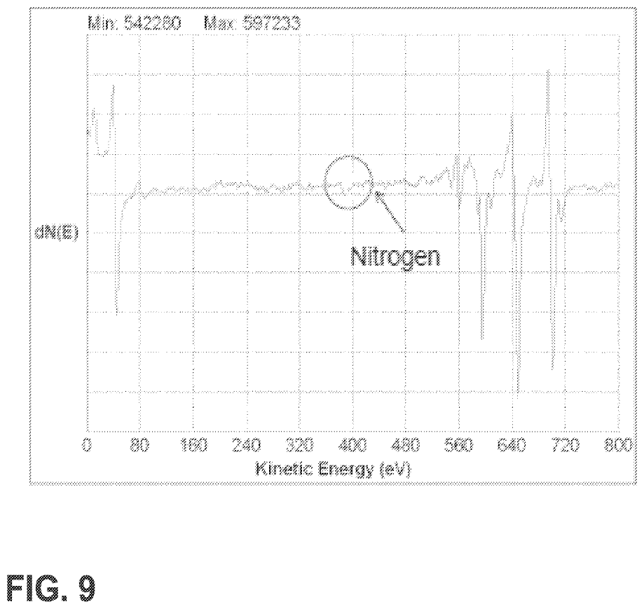

FIG. 7 is a schematic diagram illustrating an example apparatus 64 that may be used for nitriding iron wire or sheet 28 via a urea diffusion process. Such a urea diffusion process may be used to nitriding iron wire or sheet 28, e.g., when having a single crystal iron, a plurality of crystal structure, or textured structure.

Moreover, iron materials with different shapes, such as wire, sheet or bulk, can also be diffused using such a process. For wire material, the wire diameter may be varied, e.g., from several micrometers to millimeters. For sheet material, the sheet thickness may be from, e.g., several nanometers to millimeters. For bulk material, the material weight may be from, e.g., about 1 milligram to kilograms.

As shown, apparatus 64 includes crucible 66 within vacuum furnace 68. Iron wire or sheet 28 is located within crucible 66 along with the nitrogen source of urea 72. As shown in FIG. 7, a carrier gas including Ar and hydrogen is fed into crucible 66 during the urea diffusion process. In other examples, a different carrier gas or even no carrier gas may be used. In some examples, the gas flow rate within vacuum furnace 68 during the urea diffusion process may be between approximately 5 standard cubic centimeters per minute (sccm) to approximately 50 seem, such as, e.g., 20 standard cubic centimeters per minute (sccm) to approximately 50 seem or 5 standard cubic centimeters per minute (sccm) to approximately 20 seem.

Heating coils 70 may heat iron wire or sheet 28 and urea 72 during the urea diffusion process using any suitable technique, such as, e.g., eddy current, inductive current, radio frequency, and the like. Crucible 66 may be configured to withstand the temperature used during the urea diffusion process. In some examples, crucible 66 may be able to withstand temperatures up to approximately 1600° C.

Urea 72 may be heated with iron wire or sheet 28 to generate nitrogen that may diffuse into iron wire or sheet 28 to form an iron nitride material. In some examples, urea 72 and iron wire or sheet 28 may heated to approximately 650° C. or greater within crucible 66 followed by cooling to quench the iron and nitrogen mixture to form an iron nitride material having a Fe₁₆N₂ phase constitution substantially throughout the thickness or diameter of iron wire or sheet 28. In some examples, urea 72 and iron wire or sheet 28 may heated to approximately 650° C. or greater within crucible 66 for between approximately 5 minutes to approximately 1 hour. In some examples, urea 72 and iron wire or sheet 28 may be heated to between approximately 1000° C. to approximately 1500° C. for several minutes to approximately an hour. The time of heating may depend on nitrogen thermal coefficient in different temperature. For example, if the iron wire or sheet is thickness is about 1 micrometer, the diffusion process may be finished in about 5 minutes at about 1200° C., about 12 minutes at 1100° C., and so forth.

To cool the heated material during the quenching process, cold water may be circulated outside the crucible to rapidly cool the contents. In some examples, the temperature may be decreased from 650° C. to room temperature in about 20 seconds.

As will be described below, in some examples, the temperature of urea 72 and iron wire or sheet 28 may be between, e.g., approximately 200° C. and approximately 150° C. to anneal the iron and nitrogen mixture to form an iron nitride material having a Fe₁₆N₂ phase constitution substantially throughout the thickness or diameter of iron wire or sheet 28. Urea 72 and iron wire or sheet 28 may be at the annealing temperature, e.g., between approximately 1 hour and approximately 40 hours. Such an annealing process could be used in addition to or as an alternative to other nitrogen diffusion techniques, e.g., when the iron material is single crystal iron wire and sheet, or textured iron wire and sheet with thickness in micrometer level. In each of annealing and quenching, nitrogen may diffuse into iron wire or sheet 28 from the nitrogen gas or gas mixture including Ar plus hydrogen carrier gas within furnace 68. In some examples, gas mixture may have a composition of approximately 86% Ar+4% H₂+10% N₂. In other examples, the gas mixture may have a composition of 10% N₂+90% Ar or 100% N₂ or 100% Ar.

As will be described further below, the constitution of the iron nitride material formed via the urea diffusion process may be dependent on the weight ratio of urea to iron used. As such, in some examples, the weight ratio of urea to iron may be selected to form an iron nitride material having a Fe₁₆N₂ phase constitution. However, such a urea diffusion process may be used to form iron nitride materials other than that having a Fe₁₆N₂ phase constitution, such as, e.g., Fe₂N, Fe₃N, Fe₄N, Fe₈N, and the like. Moreover, the urea diffusion process may be used to diffuse nitrogen into materials other than iron. For example, such an urea diffusion process may be used to diffuse nitrogen into there are Indium, FeCo, FePt, CoPt, Cobalt, Zn, Mn, and the like.

Regardless of the technique used to nitridize iron wire or sheet 28 (14), the nitrogen may be diffused into iron wire or sheet 28 to a concentration of about 8 atomic percent (at. %) to about 14 at. %, such as about 11 at. %. The concentration of nitrogen in iron may be an average concentration, and may vary throughout the volume of iron wire or sheet 28. In some examples, the resulting phase constitution of at least a portion of the nitridized iron wire or sheet 28 (after nidtridizing iron wire or sheet 28 (14)) may be α′ phase Fe₈N. The Fe₈N phase constitution is the chemically disordered counterpart of chemically-ordered Fe₁₆N₂ phase. A Fe₈N phase constitution is also has a bct crystal cell, and can introduce a relatively high magnetocrystalline anisotropy.

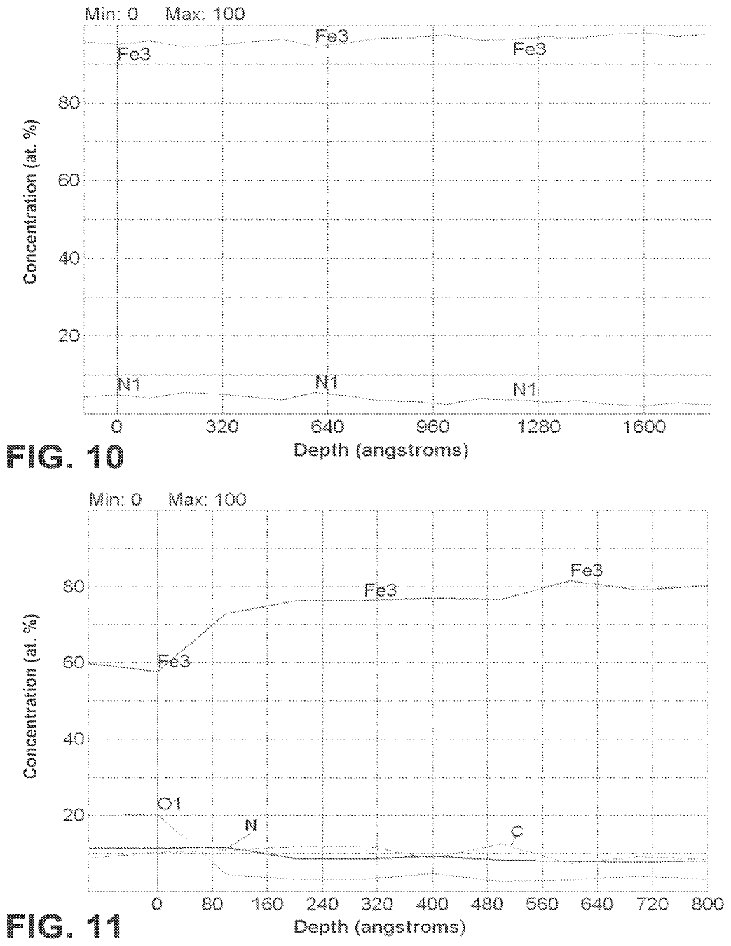

In some examples, the nitridized iron wire or sheet 28 may be α″ phase Fe₁₆N₂. FIG. 8 is an iron nitrogen phase diagram. As indicated in FIG. 8, at an atomic percent of approximately 11 at. % N, α″ phase Fe₁₆N₈ may be formed by quenching an Fe—N mixture at a temperature above approximately 650° C. for a suitable amount of time. Additionally, at an atomic percent of approximately 11 at. % N, α″ phase Fe₁₆N₈ may be formed by annealing an Fe—N mixture at a temperature below approximately 200° C. for a suitable amount of time.

In some examples, once iron wire or sheet 28 has been nitridized (14), iron wire or sheet 28 may be annealed at a temperature for a time to facilitate diffusion of the nitrogen atoms into appropriate interstitial spaces within the iron lattice to form Fe₁₆N₂ (16). FIG. 4 illustrates an example of the appropriate interstitial spaces of the iron crystal lattice in which nitrogen atoms are positioned. In some examples, the nitridized iron wire or sheet 28 may be annealed at a temperature between about 100° C. and about 300° C. In other examples, the annealing temperature may be about 126.85° C. (about 400 Kelvin). The nitridized iron wire or sheet 28 may be annealed using Crucible heating stage 26, a plasma arc lamp, a radiation heat source, such as an infrared heat lamp, an oven, or a closed retort. [0057] The annealing process may continue for a predetermined time that is sufficient to allow diffusion of the nitrogen atoms to the appropriate interstitial spaces. In some examples, the annealing process continues for between about 20 hours and about 100 hours, such as between about 40 hours and about 60 hours. In some examples, the annealing process may occur under an inert atmosphere, such as Ar, to reduce or substantially prevent oxidation of the iron. In some implementations, while iron wire or sheet 28 is annealed (16) the temperature is held substantially constant.

Once the annealing process has been completed, iron wire or sheet 28 may include a Fe₁₆N₂ phase constitution. In some examples, at least a portion of iron wire or sheet 28 consists essentially of a Fe₁₆N₂ phase constitution. As used herein “consists essentially of” means that the iron wire or sheet 28 includes Fe₁₆N₂ and other materials that do not materially affect the basic and novel characteristics of the Fe₁₆N₂ phase. In other examples, iron wire or sheet 28 may include a Fe₁₆N₂ phase constitution and a Fe₈N phase constitution, e.g., in different portions of iron wire or sheet 28. Fe₈N phase constitution and Fe₁₆N₂ phase constitution in the wires and sheets and the later their pressed assemble may exchange-couple together magnetically through a working principle of quantum mechanics. This mayl form a so-called exchange-spring magnet, which may increase the magnetic energy product even just with a small portion of Fe₁₆N.

In some examples, as described in further detail below, iron wire or sheet 28 may include dopant elements or defects that serve as magnetic domain wall pinning sites, which may increase coercivity of iron wire or sheet 28. As used herein, an iron wire or sheet 28 that consists essentially of Fe₁₆N₂ phase constitution may include dopants or defects that serve as domain wall pinning sites.

In other examples, as described in further detail below, iron wire or sheet 28 may include non magnetic dopant elements that serve as grain boundaries, which may increase coercivity of iron wire or sheet. As used herein, an iron wire or sheet 28 that consists of Fe₁₆N₂ phase constitution may include non magnetic elements that serve as grain boundaries.

Once the annealing process has been completed, iron wire or sheet 28 may be cooled under an inert atmosphere, such as argon, to reduce or prevent oxidation.

In some examples, iron wire or sheet 28 may not be a sufficient size for the desired application. In such examples, multiple iron wire or sheets 28 may be formed (each including or consisting essentially of a Fe₁₆N₂ phase constitution) and the multiple iron wire or sheets 28 may be pressed together to form a larger permanent magnet that includes or consists essentially of a Fe₁₆N₂ phase constitution (18).

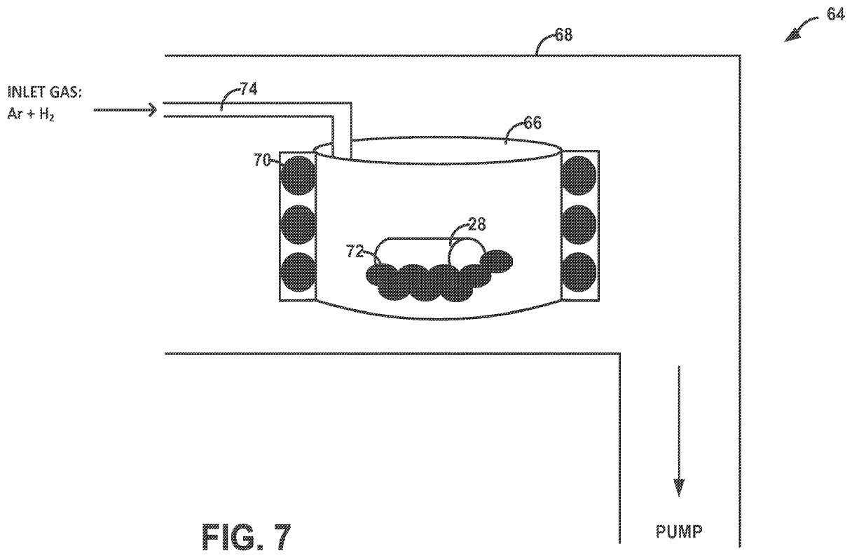

FIGS. 5A and 5B are conceptual diagrams that illustrate an example of the compression process. As shown in FIG. 5A, multiple iron wire or sheets 28 are arranged such that the <001> axes of the respective iron wire or sheets 28 are substantially aligned.

In examples in which the <001> axes of the respective iron wire or sheets 28 are substantially parallel to a long axis of the wire or sheet 28, substantially aligning the iron wire or sheets 28 may include overlying one iron wire or sheet 28 on another iron wire or sheet 28. Aligning the <001> axes of the respective iron wires or sheets 28 may provide uniaxial magnetic anisotropy to permanent magnet 52.

The multiple iron wires or sheets 28 may be compressed using, for example, cold compression or hot compression. In some examples, the temperature at which the compression is performed may be below about 300° C., as Fe₁₆N₂ may begin to degrade above about 300° C. The compression may be performed at a pressure and for a time sufficient to join the multiple iron wires or sheets 28 into a substantially unitary permanent magnet 52, as shown in FIG. 5B.

Any number of iron wires or sheets 28 may be pressed together to form permanent magnet 52. In some examples, permanent magnet 52 has a size in at least one dimension of at least 0.1 mm. In some examples, permanent magnet 52 has a size in at least one dimension of at least 1 mm. In some examples, permanent magnet 52 has a size in at least one dimension of at least 1 cm.

In some examples, in order to provide desirable high coercivity, it may be desirable to control magnetic domain movement within iron wire or sheet 28 and/or permanent magnet 52. One way in which magnetic domain movement may be controlled is through introduction of magnetic domain wall pinning sites into iron wire or sheet 28 and/or permanent magnet 52. In some examples, magnetic domain wall pinning sites may be formed by introducing defects into the iron crystal lattice. The defects may be introduced by injecting a dopant element into the iron crystal lattice or through mechanical stress of the iron crystal lattice. In some examples, the defects may be introduced into the iron crystal lattice before introduction of nitrogen and formation of the Fe₁₆N₂ phase constitution. In other examples, the defects may be introduced after annealing iron wire or sheet 28 to form Fe₁₆N₂ (16). One example by which defects that serve as domain wall pinning sites may be introduced into iron wire or sheet 28 may be ion bombardment of boron (B), copper (Cu), carbon (C), silicon (Si), or the like, into the iron crystal lattice. In other examples, powders consisting of non magnetic elements or compounds (e.g. Cu, Ti, Zr, Ta, SiO₂, Al₂O₃, etc) may be pressed together with the iron wires and sheets that comprising of Fe₁₆N₂ phase. Those non magnetic powders, with the size ranging from several nanometers to several hundred nanometers, function as the grain boundaries for Fe₁₆N₂ phase after pressing process. Those grain boundaries may enhance the coercivity of the permanent magnet.

Although described with regard to iron nitride, one or more of the examples processes describe herein may also apply to FeCo alloy to form single crystal or highly textured FeCo wires and sheets. Co atoms may replace part of Fe atoms in Fe lattice to enhance the magnetocrystalline anisotropy. Additionally, one or more of the examples strained diffusion processes described herein may also apply to these FeCo wires and sheets. Furthermore, one or more of the examples processes may also apply to diffuse Carbon (C), Boron (B) and Phosphorus (P) atoms into Fe or FeCo wires and sheets, or partially diffuse C, P, B into Fe or FeCo wires and sheets together with N atoms. Accordingly, the methods described herein may also apply to FeCo alloy to form single crystal or highly textured FeCo wires and sheets. Also, Co atoms may replace part of Fe atoms in Fe lattice, e.g., to enhance the magnetocrystalline anisotropy. Further, the method described herein may also apply to diffuse Carbon (C), Boron (B) and Phosphorus (P) atoms into Fe or FeCo wires and sheets, or partially diffuse C, P, B into Fe or FeCo wires and sheets together with N atoms. Moreover, the iron used for the processes described herein may take the shape of wire, sheet, or bulk form.

### EXAMPLE

A series of experiments were carried out to evaluate one or more aspects of example iron nitride materials described herein. In particular, various examples iron nitride materials were formed via urea diffusion and then evaluated. The weight ratio of urea to bulk iron was varied to determine the dependence of the constitution of iron nitride material on this ratio. As shown in FIG. 12, five different examples were formed using urea to iron weight ratios of approximately 0.5 (i.e., 1:2), 1.0, 1.2, 1.6, and 2.0.

For reference, at temperatures above approximately 1573° C., the main chemical reaction process for the described urea diffusion process is:

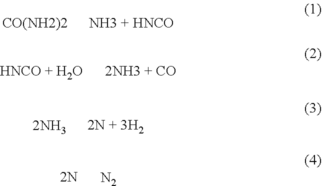

In such a reaction process, for the nitrogen atom, it may be relatively easy to recombine into a molecule, as shown in equation (4). Accordingly, in some examples, the recombination of nitrogen atoms may be decreased by placing the urea next to or proximate to the bulk iron material during a urea diffusion process. For example, in some cases, the urea may be in direct contact with the surface of the bulk iron material, or within approximately 1 centimeter of the bulk material.

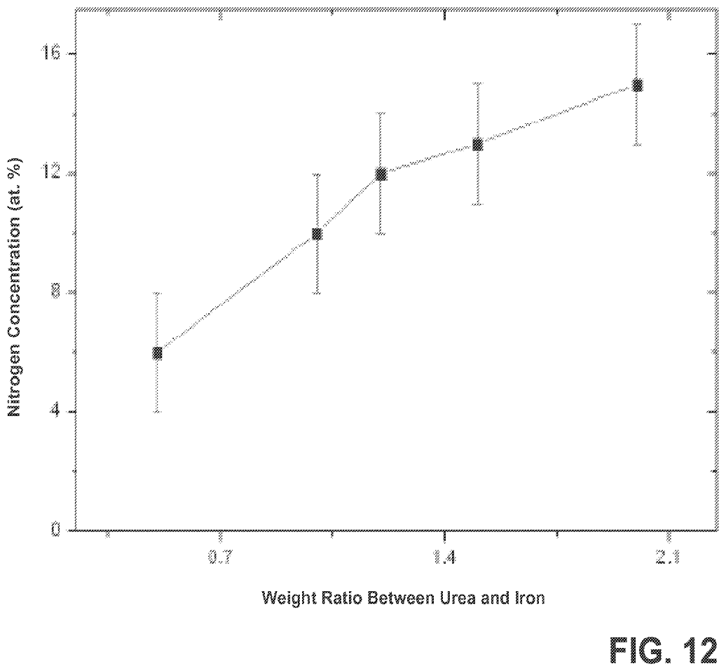

The iron nitride samples were prepared according to the urea diffusion process described herein. Following the preparation of the iron nitride sample via the urea diffusion process, Auger electron spectroscopy was used to determine the chemical composition on the surface of the example iron materials. FIG. 9 is a plot of the Auger measurement results for one of the examples, which indicates the presence of nitrogen in the material.

FIG. 12 is plot of weight ratio of urea to bulk iron material used in the urea diffusion process versus nitrogen concentration (at. %) of the final iron nitride material. As noted above, ratios of 0.5 (i.e., 1:2), 1.0, 1.2, 1.6, and 2.0 for urea to bulk iron material where used. As shown in FIG. 12, different weight ratios of urea to iron may lead to different nitrogen concentrations within the iron nitride material following urea diffusion. In particular, FIG. 12 illustrates that the atomic ratio of nitrogen in the iron nitride material increased as the amount of urea used relative to the amount bulk iron increased. Accordingly, in at least some cases, the desired nitrogen concentration of an iron nitride material formed via urea diffusion may be obtained by using the weight ratio of urea to iron in the starting material corresponding to the desired nitrogen concentration.

FIG. 10 is plot of depth below the surface of the iron nitride material versus concentration (at. %) for the iron nitride material formed via urea diffusion starting with a weight ratio of urea to iron of approximately 2.0. As shown in FIG. 10, the concentration of nitrogen from the surface of the iron nitride material to approximately 1600 angstroms below the surface of the material was approximately 6 at. %. Moreover, there isn't any trace for oxygen and carbon, which means that other dopant source(s) have been diminished effectively.

FIG. 11 is a plot of depth below the surface of the iron nitride material versus concentration (at. %) for the iron nitride material formed via urea diffusion starting with a weight ratio of urea to iron of approximately 1.0. As shown in FIG. 11, the concentration of nitrogen from the surface of the iron nitride material to approximately 800 angstroms below the surface of the material was approximately 6-12 at. %. In some examples, the concentration could be reduced further by improving the vacuum system, e.g., such as using pumping system to cause greater flow. As also show, oxygen has been diminished to be about 4 at. %. Although there is over 10 at. % carbon, since it can be considered a substitute element for nitrogen, it has no significant negative effect on the fabricated permanent magnet.

One example method comprises straining an iron wire or sheet comprising at least one iron crystal in a direction substantially parallel to a <001> crystal axis of the iron crystal to distort a unit cell structure of the at least one iron crystal and form a distorted unit cell structure having an increased length along the <001> crystal axis. The method further comprises nitridizing the iron wire or sheet to form a nitridized iron wire or sheet, and annealing the nitridized iron wire or sheet to form a Fe₁₆N₂ phase constitution at least a portion of the nitridized iron wire or sheet.

In the example method, straining the iron wire or sheet comprising the at least one iron crystal in the direction substantially parallel to the <001> crystal axis of the iron crystal may comprise applying a tensile force to the iron wire or sheet by pulling a first end of the iron wire or sheet in a first direction and pulling the second end of the iron wire or sheet in a second direction substantially opposite to the first direction.

In the example method, heating the iron wire or sheet to a temperature between about 125° C. and about 600° C. may comprise heating the iron wire or sheet to a temperature of about 125° C. for about 8.85 hours.

In the example method, heating the iron wire or sheet to a temperature of between about 125° C. and about 600° C. may comprise heating the iron wire or sheet to a temperature of about 600° C. for about 2.4 hours.

In the example method, nitridizing the iron wire or sheet to form the nitridized iron wire or sheet may comprise exposing the iron wire or sheet to an atomic nitrogen substance.

In the example method, the nitrogen precursor may be mixed with a carrier gas. The nitrogen precursor may be mixed with the carrier gas to a partial pressure of between about 0.02 and about 0.1.

In the example method, exposing the iron wire or sheet to the atomic nitrogen substance may comprise exposing the iron wire or sheet to a nitrogen precursor at a pressure between about 0.133 Pa and about 1333 Pa.

In the example method, annealing the nitridized iron wire or sheet to form the Fe₁₆N₂ phase constitution in at least the portion of the nitridized iron wire or sheet may comprise heating the nitridized iron wire or sheet to between about 100° C. and about 300° C. for between about 20 hours and about 100 hours.

In the example method, annealing the nitridized iron wire or sheet to form the Fe₁₆N₂ phase constitution in at least the portion of the nitridized iron wire or sheet may comprise annealing the nitridized iron wire or sheet under an inert atmosphere.

The example method may further comprise compressing a plurality of nitridized iron wires or sheets comprising a Fe₁₆N₂ phase constitution to form a permanent magnet comprising a Fe₁₆N₂ phase constitution.

In the example method, compressing the plurality of nitridized iron wires or sheets may comprise the Fe₁₆N₂ phase constitution to form the permanent magnet comprising the Fe₁₆N₂ phase constitution comprises cold compressing the plurality of nitridized iron wires or sheets comprising the Fe₁₆N₂ phase constitution to form the permanent magnet comprising the Fe₁₆N₂ phase constitution.

In the example method, compressing the plurality of nitridized iron wires or sheets comprising the Fe₁₆N₂ phase constitution to form the permanent magnet comprising the Fe₁₆N₂ phase constitution may comprise substantially aligning a <001> crystal axis of a first nitridized iron wire or sheet comprising the Fe₁₆N₂ phase constitution with a <001> crystal axis of a second nitridized iron wire or sheet comprising the Fe₁₆N₂ phase constitution prior to compressing the first nitridized iron wire or sheet and the second iron wire or sheet.

In the example method, compressing the plurality of nitridized iron wires or sheets comprising the Fe₁₆N₂ phase constitution to form the permanent magnet comprising the Fe₁₆N₂ phase constitution may comprise compressing the plurality of nitridized iron wires or sheets comprising the Fe₁₆N₂ phase constitution to form the permanent magnet comprising the Fe₁₆N₂ phase constitution and defining a size in at least one dimension of at least 0.1 mm.

In the example method, compressing the plurality of nitridized iron wires or sheets comprising the Fe₁₆N₂ phase constitution to form the permanent magnet comprising the Fe₁₆N₂ phase constitution may comprise compressing the plurality of nitridized iron wires or sheets comprising the Fe₁₆N₂ phase constitution to form the permanent magnet comprising the Fe₁₆N₂ phase constitution and defining a size in at least one dimension of at least 1 mm.

In the example method, nitridizing the iron wire or sheet to form the nitridized iron wire or sheet may comprise exposing the iron wire or sheet to an atomic nitrogen substance, wherein the atomic nitrogen substance is formed from urea.

In the example method, introducing magnetic domain wall pinning sites into the nitridized iron wire or sheet may comprise ion bombarding the nitridized iron wire or sheet with a dopant element.

In one example, a system comprises a strain inducing apparatus configured to exert a strain on an iron wire or sheet comprising at least one body centered cubic (bcc) iron crystal in a direction substantially parallel to a <001> axis of the bcc iron crystal, a first heating apparatus configured to heat the strained iron wire or sheet, a source of an atomic nitrogen substance configured to expose the strained iron wire or sheet to the atomic nitrogen substance to form a nitridized iron wire or sheet, and a second heating apparatus configured to heat the nitridized iron wire or sheet to a temperature sufficient to anneal the nitridized iron wire or sheet to form a Fe₁₆N₂ phase constitution in at least a portion of the nitridized iron wire or sheet.

The example system may further comprises a press configured to compress a plurality of nitridized iron wire or sheets comprising a Fe₁₆N₂ phase constitution to form a substantially unitary permanent magnet including a Fe₁₆N₂ phase constitution.

The press may be configured to compress a plurality of nitridized iron wires or sheets comprising the Fe₁₆N₂ phase constitution to form a substantially unitary permanent magnet including the Fe₁₆N₂ phase constitution and defining a size in at least one dimension of at least 0.1 mm.

The press may be configured to compress a plurality of nitridized iron wires or sheets comprising the Fe₁₆N₂ phase constitution to form a substantially unitary permanent magnet including the Fe₁₆N₂ phase constitution and defining a size in at least one dimension of at least 1 mm.

The source of the atomic nitrogen substance may comprise urea.

The example system may further comprise means for introducing magnetic domain wall pinning sites into the nitridized iron wire or sheet.

The strain inducing apparatus may comprise a first roller configured to receive a first end of the iron wire or sheet and a second roller configured to receive a second end of the iron wire or sheet, wherein the second end is substantially opposite the first end, and wherein the first roller and the second roller are configured to rotate to apply a tensile force between the first end of the iron wire or sheet and the second end of the iron wire or sheet.

The first roller and the second roller are configured to rotate to strain the iron wire or sheet between about 0.3% and about 7.0%.

The first heating apparatus may comprise, for example, a crucible heating stage, a radiation heat source or a plasma arc lamp.

The second heating apparatus may comprise, for example, a heating crucible, radiation heat source, a plasma arc lamp, an oven or a closed retort.

In one example, a permanent magnet comprises a wire comprising a Fe₁₆N₂ phase constitution. In the example permanent magnet, the wire may have a diameter of at least about 0.01 millimeters. In other examples, the wire may have a diameter of about 0.1 millimeters.

In the example permanent magnet, the wire may have an energy product of greater than about 30 MGOe. In other examples, the wire has an energy product of greater than about 60 MGOe. In other examples, the wire has an energy product of greater than about 65 MGOe. In other examples, the wire has an energy product of greater than about 100 MGOe. In other examples, the wire has an energy product of between about 60 MGOe and about 135 MGOe.

In the example permanent magnet, the wire defines a major axis extending from a first end of the wire to a second end of the wire, wherein the wire comprises at least one body centered tetragonal (bct) iron nitride crystal, and wherein a <001> axis of the at least one bct iron nitride crystal is substantially parallel to the major axis of the wire.

In one example, the permanent magnet may comprise at least one magnetic domain wall pinning site.

The example permanent magnet may further comprise a phase stabilization dopant element comprising at least one of Ti, Co, Ti, Ta, Ni, Mn, Zr, Mo, Nb, Nd, Ga, Ge, C, B, Si, P, Cr, Cu, or Zn.

In one example, the wire of the permanent magnet comprises a Fe₈N phase constitution. In another example, the wire of the permanent magnet consists essentially of the Fe₁₆N₂ phase constitution.

In another example, a permanent magnet comprises a sheet comprising a Fe₁₆N₂ phase constitution.

In some examples, the sheet may have a thickness of at least about 0.01 millimeters. In other examples, the sheet has a thickness of about 0.1 millimeters.

The sheet may have an energy product of greater than about 30 MGOe. In other examples, the sheet may have an energy product of greater than about 60 MGOe. In other examples, the sheet has an energy product of greater than about 65 MGOe. In other examples, the sheet has an energy product of greater than about 100 MGOe. In other examples, the sheet has an energy product of between about 60 MGOe and about 135 MGOe.

In examples of the permanent magnet, the sheet defines a major axis extending from a first end of the sheet to a second end of the sheet, wherein the sheet comprises at least one body centered tetragonal (bct) iron nitride crystal, and wherein a <001> axis of the at least one bct iron nitride crystal is substantially parallel to the major axis of the sheet.

In examples of the permanent magnet, the sheet further comprises a Fe₈N phase constitution.

In examples of the permanent magnet, the sheet consists essentially of the Fe₁₆N₂ phase constitution.

In another example, a permanent magnet comprises a Fe₁₆N₂ phase constitution, wherein the permanent magnet has a size in at least one dimension of at least 0.1 mm. In some examples, the permanent magnet has a size in at least one dimension of at least 1 mm. In some examples, the permanent magnet has a size in at least one dimension of at least 1 cm.

The permanent magnet may have an energy product of greater than about 30 MGOe. In other examples, the permanent magnet may have an energy product of greater than about 60 MGOe. In other examples, the permanent magnet may have an energy product of greater than about 65 MGOe. In other examples, the permanent magnet may have an energy product of greater than about 100 MGOe. In other examples, the permanent magnet may have an energy product of between about 60 MG*Oe and about 135 MG*Oe.

The permanent magnet may comprise a Fe₈N phase constitution. In another example, the permanent magnet consists essentially of the Fe₁₆N₂ phase constitution.

Another example method comprises nitridizing a metallic member via a urea diffusion process.

In one example, nitridizing a metallic member via the urea diffusion comprises heating urea and the metallic member together within a chamber to a temperature selected to decompose nitrogen atoms of the urea, wherein the nitrogen atoms diffuse into the metallic member within the chamber

The metallic member may comprise iron. In another example, the metallic member consists essentially of iron. In one example, a ratio of urea to iron is selective such that, after the urea diffusion process, the metallic member consists essentially of the Fe₁₆N₂ phase constitution.

Various examples have been described. These and other examples fall within the scope of the following claims.

What is claimed:

1. A permanent magnet comprising a Fe₁₆N₂ phase constitution, wherein the Fe₁₆N₂ phase constitution is throughout the thickness of the magnet, wherein the permanent magnet is thicker than 10 millimeter in its smallest dimension.

2. The permanent magnet of claim 1, further comprising at least one magnetic domain wall pinning site.

3. The permanent magnet of claim 1, further comprising a phase stabilization dopant element comprising at least one of Ti, Co, Ta, Ni, Mn, Zr, Mo, Nb, Nd, Ga, Ge, C, B, Si, P, Cr, Cu, or Zn.

4. The permanent magnet of claim 1, wherein the permanent magnet further comprises a Fe₈N phase constitution.

5. The permanent magnet of claim 1, wherein the permanent magnet consists essentially of the Fe₁₆N₂ phase constitution.

6. A permanent magnet comprising a Fe₁₆N₂ phase constitution, wherein the Fe₁₆N₂ phase constitution is homogeneous throughout the thickness of the magnet, wherein the permanent magnet is thicker than 0.1 millimeter in its smallest dimension.

7. The permanent magnet of claim 6, further comprising at least one magnetic domain wall pinning site.

8. The permanent magnet of claim 6, further comprising a phase stabilization dopant element comprising at least one of Ti, Co, Ta, Ni, Mn, Zr, Mo, Nb, Nd, Ga, Ge, C, B, Si, P, Cr, Cu, or Zn.

9. The permanent magnet of claim 6, wherein the permanent magnet consists essentially of the Fe₁₆N₂ phase constitution.

10. The permanent magnet of claim 6, wherein the permanent magnet is thicker than 1 millimeter in its smallest dimension.

11. The permanent magnet of claim 6, wherein the permanent magnet is thicker than 10 millimeters in its smallest dimension.

12. A method of forming a permanent magnet comprising the steps of:
nitridizing an iron wire or sheet comprising at least one iron crystal, to form a nitridized iron wire or sheet;
annealing the nitridized iron wire or sheet to form a Fe₁₆N₂ phase constitution in at least a portion of the nitridized iron wire or sheet; and
compressing a plurality of nitridized iron wires or sheets to form the permanent magnet.

13. The method of claim 12, wherein during the nitridizing the iron wire or sheet step:
straining the iron wire or sheet in a direction parallel to a <001> crystal axis of the at least one iron crystal to distort a unit cell structure of the at least one iron crystal and form a distorted unit cell structure having an increased length along the <001> crystal axis.

14. The method of claim 12, wherein the permanent magnet comprises at least one magnetic domain wall pinning site.

15. The method of claim 12, wherein the permanent magnet comprises a phase stabilization dopant element comprising at least one of Ti, Co, Ta, Ni, Mn, Zr, Mo, Nb, Nd, Ga, Ge, C, B, Si, P, Cr, Cu, or Zn.

16. The method of claim 12, wherein the permanent magnet consists essentially of the Fe₁₆N₂ phase constitution.

17. The method of claim 12, wherein the permanent magnet is thicker than 1 millimeter in its smallest dimension.

18. The method of claim 12, wherein the permanent magnet is thicker than 10 millimeters in its smallest dimension.
